(19) United States
(12) Patent Application Publication
(10) Pub. No.: US 2026/0327375 A1
(43) Pub. Date: Oct. 22, 2026

(54) ISOSORBIDE-BASED POLYCARBONATE WITH LOWER CHROMATICITY AND PREPARATION METHOD THEREOF

(71) Applicant: Puyang Shengtongjuyuan New Material Co., Ltd., Puyang (CN)

(72) Inventors: Hualong Lu, Zhengzhou (CN); Xichen Wang, Puyang (CN); Mingyong Zhang, Liaocheng (CN); Zhaomin Guo, Puyang (CN); Senqiang Hou, Puyang (CN)

(21) Appl. No.: 19/696,652

(22) Filed: Jun. 3, 2026

(30) Foreign Application Priority Data
Sep. 3, 2025 (CN) 202511256220.5

(51) Int. Cl. C08G 64/30; C08G 64/16; C08K 3/38

(52) U.S. Cl. CPC C08G 64/302; C08G 64/1608; C08G 64/305; C08K 3/38

(57) ABSTRACT

Disclosed is an isosorbide-based polycarbonate with lower chromaticity and a preparation method thereof. The preparation method includes mixing diphenyl carbonate, isosorbide, and 1,4-cyclohexanedimethanol and stirring at a certain temperature, after stirring evenly, adding a catalyst aqueous solution, after the moisture in the reaction system is removed, increasing the reaction system temperature to 160-170 °C for ester exchange reaction, and reducing the vacuum degree of the reaction system to 26-28 kPa to remove by-product phenol; then continuing to increase the reaction temperature to 210-230 °C for polycondensation reaction, reducing the vacuum of the reaction system to 80-500 Pa to remove phenol and light components, and after the polycondensation reaction is completed, condensing and pelletizing to obtain isosorbide-based polycarbonate with lower chromaticity. It reduces the reaction temperature by compounding relevant catalysts and antioxidants, thereby inhibiting the isosorbide oxidation reaction, reducing product color, and expanding the application range of isosorbide-based polycarbonate.

### CROSS-REFERENCE TO RELATED APPLICATIONS

This application claims to the benefit of priority from Chinese Application No. 202511256220.5 with a filing date of Sep. 3, 2025. The content of the aforementioned applications, including any intervening amendments thereto, are incorporated herein by reference.

### TECHNICAL FIELD

The present disclosure relates to the technical field of isosorbide-based polycarbonate, in particular to an isosorbide-based polycarbonate with lower chromaticity and a preparation method.

### BACKGROUND

Isosorbide-based polycarbonate is an important type of polycarbonate, which has excellent thermal properties, optical properties and biocompatibility, and is widely used in medical, food, engineering plastics, and other fields.

High optical transparency biobased polycarbonate is commonly used in optical lenses, medical instruments, food containers, and other fields, which set extremely high standards for the intrinsic purity and transparency of materials. Any trace amount of coloring or haze will directly damage the optical performance of the final product, affecting its aesthetic appeal and market acceptance. At the same time, the excellent transparency exhibited by isosorbide-based polycarbonate shows excellent modifiability, making it easy to customize through subsequent processing techniques such as dyeing or surface coating to meet the diverse design needs of downstream enterprises.

The reason for affecting the chromaticity of isosorbide-based polycarbonate: during the ester exchange reaction, the secondary hydroxyl groups in the isosorbide molecules are prone to oxidation at high temperatures to form carbonyl groups (such as isosorbide-based ketone), which have chromophoric properties and cause yellowing of isosorbide-based polycarbonate.

In view of this, the present disclosure is proposed.

### SUMMARY

The objective of the present disclosure is to provide an isosorbide-based polycarbonate with lower chromaticity and a preparation method thereof. By selecting suitable catalysts and antioxidants, lowering the reaction temperature, inhibiting the oxidation reaction of isosorbide, thereby reducing the product chromaticity.

In order to achieve the above objective of the present disclosure, the following technical solutions are adopted:

First, the present disclosure provides a preparation method of isosorbide-based polycarbonate with lower chromaticity, including the following steps:
(a) mixing diphenyl carbonate, isosorbide, and 1,4-cyclohexanedimethanol and heating to 110-130 °C, after the diphenyl carbonate and isosorbide melt, adding a mixed aqueous solution of catalyst and antioxidant, mixing uniformly and removing moisture at the vacuum of 29-32 kpa and a stirring speed of 100-150 rpm;
(b) under the condition of keeping stirring speed unchanged, increasing a temperature of reaction kettle to 160-170 °C for ester exchange reaction, and adjusting the vacuum to 26-28 kPa to remove by-product phenol;
(c) under a condition of keeping the stirring speed and the reaction temperature unchanged, keeping the reaction for a period of time under the vacuum of 12-18 kPa;
(d) performing an esterification reaction at the temperature of 160-170 °C, the stirring speed of 50-100 rpm, and the vacuum of 4-6 kPa;
(e) under a condition of keeping the stirring speed unchanged, increasing the temperature of the reaction kettle to 210-230 °C and adjusting the vacuum to 70-90 Pa for a polycondensation reaction;
(f) after the polycondensation reaction is completed, condensing and pelletizing the reaction product to obtain isosorbide-based polycarbonate with lower chromaticity.

Preferably, in step (a), the mass ratio of diphenyl carbonate, isosorbide, 1,4-cyclohexanedimethanol, and catalyst is (8-12):(3-8):(1.5-4):(0.01-0.15).

Preferably, in step (a), the mixed aqueous solution of catalyst and antioxidant is a mixed aqueous solution of cesium carbonate and sodium borohydride, wherein the concentration of cesium carbonate is 0.2‰-0.4‰, and the concentration of sodium borohydride is 0.05‰-0.10‰.

Preferably, in step (b), the ester exchange reaction time is 1.2-1.8 h.

Preferably, in step (c), the period time of keeping the reaction is 0.5-1 h.

Preferably, in step (d), the esterification reaction time is 0.8-1.2 h.

Preferably, in step (e), the polycondensation reaction time is 0.5-1 h.

Second, the present disclosure provides an isosorbide-based polycarbonate with lower chromaticity prepared by the above preparation method.

Compared with existing technologies, the advantageous effects of the present disclosure at least include:

The preparation method of the present disclosure reduces the reaction temperature by selecting suitable catalysts and antioxidants, thereby inhibiting the isosorbide oxidation reaction, reducing the chroma of the product, better meeting market demand, and expanding the application range of isosorbide-based polycarbonate.

### DETAILED DESCRIPTION OF THE EMBODIMENTS

The embodiments of the technical solution of the present disclosure will be described in detail below with reference to the embodiments. The following embodiments are only intended to illustrate the technical solution of the present disclosure more clearly, and are therefore provided as examples only, and shall not be construed as limiting the protection scope of the present disclosure.

It should be noted that, unless otherwise specified, the technical term or scientific term used in this application should have the usual meanings understood by those skilled in the art to which the present disclosure belongs.

The embodiments of the present disclosure provide a preparation method of isosorbide-based polycarbonate with lower chromaticity, including the following steps:
(a) Mixing diphenyl carbonate, isosorbide, and 1,4-cyclohexanedimethanol and heating to 110-130 °C. After the diphenyl carbonate and isosorbide melt, adding a mixed aqueous solution of catalyst and antioxidant, mixing uniformly and removing moisture at vacuum of 29-32 kpa and stirring speed of 100-150 rpm;
(b) Under the condition of keeping stirring speed unchanged, heating the reaction kettle to 160-170 °C for ester exchange reaction, and adjusting the vacuum to 26-28 kPa to remove the by-product phenol;
(c) Under the condition of keeping the stirring speed and the reaction temperature unchanged, keeping the reaction under a vacuum of 12-18 kPa for a period of time;
(d) Performing esterification reaction at the temperature of 160-170 °C, stirring speed of 50-100 rpm and vacuum of 4-6 kPa;
(e) Under the condition of keeping the stirring speed unchanged, increasing the temperature of the reaction kettle to 210-230 °C and adjusting the vacuum to 70-90 Pa for polycondensation reaction;
(f) After the polycondensation reaction is completed, condensing and pelletizing the reaction product to obtain the isosorbide-based polycarbonate with lower chromaticity.

The preparation method of the present disclosure reduces the reaction temperature and inhibits the oxidation reaction of isosorbide by selecting suitable catalysts, thereby reducing the product chromaticity, thereby better meeting market demands and expanding the application scope of isosorbide-based polycarbonate.

In one embodiment, the mass ratio of diphenyl carbonate, isosorbide, 1,4-cyclohexanedimethanol, and catalyst in step (a) is (8-12):(3-8):(1.5-4):(0.01-0.15).

In one embodiment, in step (a), the mixed aqueous solution of catalyst and antioxidant are a mixed aqueous solution of cesium carbonate and sodium borohydride, wherein the concentration of cesium carbonate is 0.2‰ to 0.4‰, and the concentration of sodium borohydride is 0.05‰ to 0.10‰.

In one embodiment, the ester exchange reaction time in step (b) is 1.2 h to 1.8 h.

In one embodiment, in step (c), the reaction is kept for a period of time ranging from 0.5 h to 1 h.

In one embodiment, the esterification reaction time in step (d) is 0.8 h to 1.2 h.

In one embodiment, the polycondensation reaction time in step (e) is 0.5 h to 1 h.

Another embodiment of the present disclosure provides an isosorbide-based polycarbonate with lower chromaticity prepared by the above preparation method.

The following provides further detailed explanations of the technical solution of the present disclosure through specific embodiments.

### Embodiment 1

This embodiment provides a preparation method of isosorbide-based polycarbonate with lower chromaticity, including the following steps:
(a) Mixing diphenyl carbonate, isosorbide, and 1,4-cyclohexanedimethanol and heating to 120 °C. After the diphenyl carbonate and isosorbide melt, adding a mixed aqueous solution of catalyst and antioxidant, mixing uniformly and removing moisture at the temperature of 130 °C, vacuum of 30 kpa, and stirring speed of 150 rpm. The mass ratio of diphenyl carbonate, isosorbide, 1,4-cyclohexanedimethanol, and catalyst is 10.8:7:3:0.024; the mixed aqueous solution of catalyst and antioxidant is a mixed aqueous solution of cesium carbonate and sodium borohydride, where the concentration of cesium carbonate is 0.4‰ and the concentration of sodium borohydride is 0.050‰;
(b) Under the condition of keeping stirring speed unchanged, heating up to 160 °C for 1.5 h of ester exchange reaction, and adjusting the vacuum to 27 kPa to remove the by-product phenol;
(c) Under the condition of keeping the stirring speed and reaction temperature unchanged, keeping the reaction for 1 h under the vacuum of 15 kPa;
(d) Performing esterification reaction at the temperature of 160 °C, stirring speed of 100 rpm, and vacuum of 5 kPa for 1 h;
(e) Under the condition of keeping the same stirring speed unchanged, increasing the temperature of the reaction kettle to 220 °C and adjusting the vacuum to 80 Pa for polycondensation reaction for 40 min;
(f) After the polycondensation reaction is completed, condensing and pelletizing the reaction product to obtain the isosorbide-based polycarbonate with lower chromaticity.

### Embodiment 2

This embodiment provides a preparation method of isosorbide-based polycarbonate with lower chromaticity, including the following steps:
(a) Mixing diphenyl carbonate, isosorbide, and 1,4-cyclohexanedimethanol and heating to 120 °C. After the diphenyl carbonate and isosorbide melt, adding a mixed aqueous solution of catalyst and antioxidant, mixing uniformly and removing moisture at the temperature of 130 °C, vacuum of 30 kpa, and stirring speed of 150 rpm. The mass ratio of diphenyl carbonate, isosorbide, 1,4-cyclohexanedimethanol, and catalyst is 10.8:7:3:0.024; the mixed aqueous solution of catalyst and antioxidant is a mixed aqueous solution of cesium carbonate and sodium borohydride, where the concentration of catalyst cesium carbonate is 0.32‰ and the concentration of sodium borohydride is 0.08‰;
(b) Under the condition of keeping stirring speed unchanged, heating up to 160 °C for 1.5 h of ester exchange reaction, and adjusting the vacuum to 27 kPa to remove the by-product phenol;
(c) Under the condition of keeping the stirring speed and reaction temperature unchanged, keeping the reaction for 1 h under the vacuum of 15 kPa;
(d) Performing esterification reaction at the temperature of 160 °C, stirring speed of 100 rpm, and vacuum of 5 kPa for 1 h;
(e) Under the condition of keeping the same stirring speed unchanged, increasing the temperature of the reaction kettle to 220 °C and adjusting the vacuum to 80 Pa for polycondensation reaction for 40 min;
(f) After the polycondensation reaction is completed, condensing and pelletizing the reaction product to obtain the isosorbide-based polycarbonate with lower chromaticity.

### Embodiment 3

This embodiment provides a preparation method of isosorbide-based polycarbonate with lower chromaticity, including the following steps:
(a) Mixing diphenyl carbonate, isosorbide, and 1,4-cyclohexanedimethanol and heating to 120 VC. After the diphenyl carbonate and isosorbide melt, adding a mixed aqueous solution of catalyst and antioxidant, mixing uniformly and removing moisture at the temperature of 130 °C, vacuum of 30 kpa, and stirring speed of 150 rpm. The mass ratio of diphenyl carbonate, isosorbide, 1,4-cyclohexanedimethanol, and catalyst is 10.8:7:3:0.024; the mixed aqueous solution of catalyst and antioxidant is a mixed aqueous solution of cesium carbonate and sodium borohydride, where the concentration of cesium carbonate is 0.32‰ and the concentration of sodium borohydride is 0.05‰;
(b) Under the condition of keeping stirring speed unchanged, heating up to 160 °C for 1.5 h of ester exchange reaction, and adjusting the vacuum to 27 kPa to remove the by-product phenol;
(c) Under the condition of keeping the stirring speed and reaction temperature unchanged, keeping the reaction for 1 h under the vacuum of 15 kPa;
(d) Performing esterification reaction at the temperature of 160 °C, stirring speed of 100 rpm, and vacuum of 5 kPa for 1 h;
(e) Under the condition of keeping the same stirring speed unchanged, increasing the temperature of the reaction kettle to 220 °C and adjusting the vacuum to 80 Pa for polycondensation reaction for 1 h;
(f) After the polycondensation reaction is completed, condensing and pelletizing the reaction product to obtain the isosorbide-based polycarbonate with lower chromaticity.

### Experimental Example

The isosorbide-based polycarbonate with lower chromaticity prepared in embodiments 1 to 3 were obtained respectively;

The chromaticity of the above-mentioned isosorbide-based polycarbonate with lower chromaticity was detected using a colorimeter method, and the detection results are shown in Table 1.

TABLE 1

| | |
|---|---|
| Group | Chromaticity |

| | | | |
|---|---|---|---|
| Embodiment 1 | L: 59.34 | a: 3.12 | b: 11.8 |
| Embodiment 2 | L: 62.41 | a: 0.04 | b: 4.21 |
| Embodiment 3 | L: 59.45 | a: 0.28 | b: 8.46 |

According to Table 1, it can be seen that:

The isosorbide-based polycarbonate prepared in the present embodiment has lower chromaticity, and compared with different embodiments, the isosorbide-based polycarbonate prepared in embodiment 2 has lower chromaticity.

Finally, it should be noted that the above embodiments are only used to illustrate the technical solution of the present disclosure, and not to limit it; although the present disclosure has been described in detail with reference to the aforementioned embodiments, those skilled in the art should understand that they can still modify the technical solutions described in the aforementioned embodiments, or equivalently replace some or all of the technical features; and these modifications or substitutions do not depart from the essence of the corresponding technical solutions from the scope of the technical solutions of the embodiments of the present disclosure, and they should all be covered within the scope of the claims and specification of the present disclosure.

What is claimed is:

1. A preparation method of isosorbide-based polycarbonate with lower chromaticity, including the following steps:
(a) mixing diphenyl carbonate, isosorbide, and 1,4-cyclohexanedimethanol and heating to 110-130 °C, after the diphenyl carbonate and isosorbide melt, adding a mixed aqueous solution of catalyst and antioxidant, mixing uniformly and removing moisture at a vacuum of 29-32 kpa and a stirring speed of 100-150 rpm;
(b) under a condition of keeping the stirring speed unchanged, increasing a temperature of reaction kettle to 160-170 °C for ester exchange reaction, and adjusting a vacuum to 26-28 kPa to remove by-product phenol;
(c) under a condition of keeping the stirring speed and the reaction temperature unchanged, keeping a reaction for a period of time under a vacuum of 12-18 kPa;
(d) performing an esterification reaction at a temperature of 160-170 °C, a stirring speed of 50-100 rpm, and a vacuum of 4-6 kPa;
(e) under a condition of keeping the stirring speed unchanged, increasing a temperature of the reaction kettle to 210-230 °C, and adjusting a vacuum to 70-90 Pa for a polycondensation reaction;
(f) after the polycondensation reaction is completed, condensing and pelletizing a reaction product to obtain isosorbide-based polycarbonate with lower chromaticity.

2. The preparation method according to claim 1, wherein in step (a), a mass ratio of diphenyl carbonate, isosorbide, 1,4-cyclohexanedimethanol, and catalyst is (8-12):(3-8):(1.5-4):(0.01-0.15).

3. The preparation method according to claim 1, wherein in step (a), a mixed aqueous solution of catalyst and antioxidant is a mixed aqueous solution of cesium carbonate and sodium borohydride, a concentration of cesium carbonate is 0.2‰-0.4‰, and a concentration of sodium borohydride is 0.05‰-0.10‰.

4. The preparation method according to claim 1, wherein in step (b), a time of the ester exchange reaction is 1.2-1.8 h.

5. The preparation method according to claim 1, wherein in step (c), a period time of keeping the reaction is 0.5-1 h.

6. The preparation method according to claim 1, wherein in step (d), a time of the esterification reaction is 0.8-1.2 h.

7. The preparation method according to claim 1, wherein in step (e), a time of the polycondensation reaction is 0.5-1 h.

8. An isosorbide-based polycarbonate with lower chromaticity prepared by the preparation method according to claim 1.
